(19) United States
(12) Patent Application Publication
(10) Pub. No.: US 2018/0360285 A1
(43) Pub. Date: Dec. 20, 2018

(54) SYSTEM OF AT LEAST ONE HOUSEHOLD APPLIANCE, AT LEAST ONE AUTOMATICALLY MOVING CLEANING DEVICE AND A CONTROL DEVICE

(71) Applicant: Vorwerk & Co. Interholding GmbH, Wuppertal (DE)

(72) Inventors: David ERKEK, Aarau (CH); Georg HACKERT, Bochum (DE); Gerhard ISENBERG, Koeln (DE); Roman ORTMANN, Huerth (DE); Andreas SCHMIDT, Mettmann (DE)

(73) Assignee: Vorwerk & Co. Interholding GmbH, Wuppertal (DE)

(21) Appl. No.: 16/002,266

(22) Filed: Jun. 7, 2018

(30) Foreign Application Priority Data
Jun. 16, 2017 (DE) 10 2017 113 279.1

(51) Int. Cl. A47L 11/40; G05D 1/00; G05D 1/02; G05B 15/02

(52) U.S. Cl. CPC A47L 11/4011; G05D 1/0011; G05D 1/0276; D06F 35/00; G05B 15/02; G05D 2201/0215; G05D 1/0038

(57) ABSTRACT

A system has at least one household appliance, at least one automatically moving cleaning device, and a control device for controlling an operation of the cleaning device. To attain a fully automatic operation of the system, the control device is set up to control an operation of the cleaning device as a function of an operating status of the household appliance.

### CROSS REFERENCE TO RELATED APPLICATIONS

Applicant claims priority under 35 U.S.C. § 119 of German Application No. 10 2017 113 279.1 filed Jun. 16, 2017, the disclosure of which is incorporated by reference

### BACKGROUND OF THE INVENTION

### 1. Field of the Invention

The invention relates to a system of at least one household appliance, at least one automatically moving cleaning device and a control device for controlling an operation of the cleaning device.

The invention furthermore relates to a method for operating a system of at least one household appliance, at least one automatically moving cleaning device, and a control device for controlling an operation of the cleaning device.

### 2. Description of the Related Art

Household appliances and cleaning devices are known in a plurality of embodiments in the prior art.

Household appliances can be, for example, kitchen machines, washing machines, dishwashers, ovens, hotplates, coffee makers or also cleaning devices, such as vacuum cleaners or mopping devices.

Automatically moving cleaning devices are known in the prior art for example as robot vacuum cleaners or mopping robots. The automatically moving cleaning devices have a navigation device, by means of which the cleaning device can orientate itself in a surrounding area. The navigation device typically includes a detection device, for example an image capturing device, such as a camera or a distance measuring device, which records data from the surrounding area, which is ultimately combined to form a surrounding area map. The cleaning device can navigate through the surrounding area in a collision-free manner by means of the surrounding area map and can estimate its own position.

It is furthermore known to control household appliances or cleaning devices, respectively, by means of an internal or external control device. In terms of an internal control device, the control device is a local control device, which is integrated in the household appliance or the cleaning device, respectively. External control devices are, for example, remote controls and/or mobile communication devices of a user, with the help of which the household appliance or the cleaning device, respectively, can be controlled remotely via a communication connection.

It is furthermore known in the prior art, for example from EP 1 967 116 B2, to automatically control a cleaning device as a function of a detected soiling. A sensor device of the cleaning device detects a degree of soiling of a floor surface, whereupon an operation of the cleaning device is controlled as a function of the degree of soiling, if necessary.

### SUMMARY OF THE INVENTION

Based on the above-mentioned prior art, it is the object of the invention to have a household appliance and an automatically moving cleaning device cooperate with one another in an advantageous manner, in particular fully automatically.

To solve this object, a system of at least one household appliance, at least one automatically moving cleaning device and a control device for controlling an operation of the cleaning device is initially proposed, wherein the control device is set up to control an operation of the cleaning device as a function of an operating status of the household appliance.

According to the invention, the household appliance and the cleaning device now do not longer work independently from one another, but are linked with one another with regard to their operation in such a way that the operation of the cleaning device is a function of the current operating status of the household appliance. The operation of the cleaning device can thereby be a function of a current use (active) or non-use (not active), respectively, of the type of the current operation or another operating status of the household appliance. The control device of the system can in particular be embodied and set up to control the cleaning device in such a way at the beginning and/or after ending an operation of the household appliance that the cleaning device performs a cleaning operation at the location of the household appliance.

It is proposed that the household appliance is a kitchen machine, a window cleaning device, a washing machine or a clothes dryer. A soiling of the surrounding area can occur during the operation of these household appliances, in particular when loading or emptying the respective household appliance. In the case of a kitchen machine, it may happen, for example, that food, which is filled into a vessel, falls to the floor. In the case of a window cleaning device and/or a washing machine, it may happen that liquid drops out of the household appliance and hits a floor surface. In the case of a clothes dryer, lint frequently falls down from a lint filter and hits the floor after a concluded drying of the laundry located in the clothes drier. In the field of all of these household appliances, it is thus required to clean a surrounding room area, in particular an adjacent floor surface. This typically requires a cleaning by means of vacuuming and/or mopping. The point in time, at which the soiling occurs, thereby coincides with the current operating status of the household appliance. This point in time is typically either a point in time immediately prior to the operation of the household appliance or upon completion of the operation. In the case of a kitchen machine, a likelihood for a soiling at the point in time of the operating status “filling the vessel” is particularly high, while in the case of a washing machine or of a laundry dryer, a soiling is instead particularly likely at the point in time of the operating status “emptying the household appliance”. The control device of the system receives the information about the operating status of the household appliance and then controls the cleaning device in such a way that the typically resulting soiling is eliminated. The control device can obtain the information about the current operating status of the household appliance by an inquiry at the respective household appliance or by receiving a status signal transmitted by the household appliance. It goes without saying that, in addition to the above-mentioned household appliances, other household appliances can also be linked within the system. An integration of a household appliance into the system is advisable in particular when it can profit from a cleaning by means of the cleaning device, namely when a soiling typically occurs by the household appliance.

It is proposed that the control device is an integrated control device of the cleaning device or an external control device, wherein the control device has a communication connection to the cleaning device and to the household appliance. The control device of the system can thus either be a control device, which is installed in the cleaning device, or, in the alternative, a separate control device, which is arranged outside of the household appliance and of the cleaning device. It is in particular also possible that the control device is assigned to a webserver, in particular to a so-called cloud.

The household appliance and the cleaning device are advantageously registered at the control device, wherein the control device in particular includes information about the respective appliance type and a device location of the appliance. An external input device, in particular a mobile communication device of a user, via which the user can make an input, in particular a registration of the respective device, can thereby advantageously also be assigned to the control device. The input device can in particular be a mobile telephone, a laptop or a tablet computer. Provided that the control device is a component of the cleaning device, a registration of another cleaning device or of one or a plurality of household appliances of the system can advantageously occur manually via the operating device thereof or preferably via wireless communication by means of an external end device. For this purpose, a mobile telephone of the user or the like can also be suitable again, when a corresponding application is installed on the end device.

It is furthermore proposed that the system has a communication network, in which the household appliance and the cleaning device are in communication connection with one another. The communication network can advantageously be a radio network. The communication between the devices of the system and the control device could take place, for example, via WLAN, Bluetooth or Zigbee. A wired communication is furthermore also possible, in particular via PowerLAN. Advantageously, the communication network is a communication network of a home automation system, which has a plurality of household appliances and/or cleaning devices, which are connected to a central control device. The central control device is thereby embodied to receive information from the devices and to transmit information to the devices, wherein an operating status of a household appliance can be transmitted to the central control device continuously or at certain intervals or on certain occasions. The home automation system can furthermore include a plurality of other devices, for example shutters, a heating system, a ventilating system, a lighting device, a video-audio system and the like.

The control device and/or the cleaning device can furthermore have a surrounding area map, which includes the surrounding area of the cleaning device and/or the surrounding area of the system. The surrounding area map advantageously includes information about a position of the household appliance and of the cleaning device as well as additional information about for example an operating status of the household appliance and/or of the cleaning device, if applicable. The control device thus has knowledge about the relevant information of the household appliances and/or cleaning devices linked in the system, so that one of a plurality of available cleaning devices can be selected, which can best serve the household appliance, which currently needs a cleaning service. It is not absolutely required that the information as such is written into the surrounding area map. In fact, a separate file, which includes information about the device, here for example an operating status of the household appliance, can be linked with a cleaning device and/or household appliance stored in the surrounding area map. Prior to a calculation of an operating strategy, the control device of the system can access this file and can query corresponding information about the household appliance and/or the cleaning device. Information about a household appliance can, for example, also relate to a position, a size of a standing surface and/or a set-up height of the household appliance relative to a floor surface. With this information, the control device of the system receives an indication as to which surrounding area of the household appliance can be soiled, in order to accordingly control an operation of the cleaning device in such a way that the soiling is eliminated completely.

The operation of the cleaning device, which is controlled by the control device, can serve a plurality of different tasks, for example include a cleaning using suction and/or mopping. For example, a disinfection, odor neutralization, a polishing, sanding, blowing away or the like is furthermore also possible.

In addition to the above-described system, the invention furthermore also proposes a method for operating a system of at least one household appliance, at least one automatically moving cleaning device, and a control device for controlling an operation of the cleaning device, wherein the control device controls an operation of the cleaning device as a function of an operating status of the household appliance. As described above with regard to the system according to the invention, the method can now be used to perform a cleaning in the area of the household appliance, namely by means of a cleaning device, which is linked with the household appliance via the system, in the event of a defined operating status of the household appliance. For this purpose, a current operating status of the household appliance is transmitted to the control device and a corresponding control command, which corresponds to the operating status of the household appliance, is generated by the control device. A cleaning can in particular be controlled at the location of the household appliance at the beginning, during or after the use of the household appliance.

To link the household appliance and the cleaning device or a plurality of household appliances and/or a plurality of cleaning devices, respectively, inside the system, it is required that they are initially registered in the system. For this purpose, it is proposed that the household appliance and/or the cleaning device transmits its device type, current device location and/or current operating status to the control device. The transmission of this information to the control device can for example occur by means of a manual input at an input interface of the control device, or an external appliance, which is in communication connection therewith, or automatically in that for example corresponding information from the cleaning device and/or the household appliance is scanned. For this purpose, the household appliance and/or the cleaning device can transmit a code, which includes information, to the control device and/or can for example bear a code, in particular a bar code or QR code, on an outer housing side.

It is furthermore proposed that the control device outputs a control command for moving the cleaning device to the current device location of the household appliance and for performing a cleaning operation at the device location, whereupon the cleaning device moves to the household appliance and performs a cleaning there. For example, a household appliance of the system can transmit an operating status to the control device, which signals that an operation has been concluded successfully. The control device then checks, which service task is required when this operating status appears, and which cleaning device of the system is available for this purpose. A current location of the cleaning devices can be considered thereby. The control device then transmits a control command to the selected cleaning device, so that the latter moves to the device location of the household appliance and performs a cleaning there. Provided that a plurality of cleaning devices is available inside the system, it can also be checked, among other things, which cleaning device is located closest to the device location of the household appliance, which cleaning device is currently available for a cleaning operation, and whether persons are located within a movement path between the current location of the cleaning device and the device location of the household appliance.

One embodiment can provide, for example, that a household appliance, which is embodied as multi-functional kitchen machine, performs an automatic preparation of food by means of an integrated preparation control. This household appliance signals for example to the control device, when a preparation starts and/or has been completed. The control device then checks, if applicable, when a next cleaning cycle of a cleaning device of the system is planned and, if applicable, adapts it in such a way that a cleaning can be performed as soon as possible at the device location of the household appliance. It can be considered thereby that persons are not present in the area to be cleaned, because they could interfere with the performance of the cleaning.

According to a further exemplary embodiment, the household appliance can for example be a microwave, a stove, an oven or a dishwasher. In the case of a dishwasher, a cleaning operation could be started by the cleaning device, for example with the start of a cleaning operation of the dishwasher, in order to clean soiling, which reached a floor surface in response to the loading of the dishwasher. According to this embodiment, the information for the control device that a loading has been concluded, results simultaneously as a result of the start of operation of the dishwasher.

According to a further embodiment, drops of liquid and/or lint can fall down onto a floor surface in response to an emptying of a dishwasher, of a washing machine or of a dryer. The household appliance thus signals to the control device for example that a cleaning operation has concluded and that the household appliance is opened. The control device then processes this information into a control command for the cleaning device, in order to prompt a cleaning by means of the cleaning device.

A further embodiment can provide for the household appliance to be a window cleaner, which performs a cleaning of a window surface by means of liquid. Upon completion of a cleaning operation of the window cleaner, information about the concluded cleaning can be transmitted to the control device. The site of operation of the window cleaner is advantageously also reported with this information, so that the cleaning device can be controlled to that device location of the household appliance, in which a soiling has occurred, if applicable.

It is furthermore advisable that a cleaning type of the cleaning device is adapted as a function of the type of the household appliance. Provided that the household appliance is a window cleaner, for example a wet cleaning by means of a cleaning device is advisable. In contrast, it may be advisable to perform a dry cleaning in the case of a household appliance, which is embodied as multifunctional kitchen machine. In the alternative, the type of cleaning can also be controlled via the content of certain recipe steps of the kitchen machine, in particular when ingredients, such as flour, fat, oil and the like were used.

It is in particular proposed that a control command for the cleaning device is output at the beginning and/or upon completion of an operation of the household appliance. As described above, a soiling of an adjacent floor surface occurs in particular in response to a loading or an emptying of a household appliance. The beginning or the completion, respectively, of the operation of the household appliance thus specifies the relevant point in time for controlling an operation of the cleaning device in a timely manner.

It is furthermore proposed that the control device transmits a confirmation inquiry to a user of the system prior to transmitting a control command to the cleaning device, wherein in particular a confirmation inquiry is displayed on a mobile end device of the user. The user can in particular receive an inquiry, for example from an application installed on a mobile telephone, as to whether a cleaning is to be performed by means of the cleaning device, which one of a plurality of cleaning devices is to be used, whether the cleaning is to take place immediately or at a later point in time, which cleaning means, for example cleaning liquid, is to be used, and the like. A cleaning of the cleaning device is controlled only after a certain selection or confirmation of the respective inquiry by the user. The mobile end device of the user can in particular be a mobile telephone, a laptop, a tablet computer or the like. According to a particularly simple embodiment, provision can furthermore also be made for the configuration inquiry to be displayed on a display of the cleaning device itself, or also on a display of the household appliance. Provided that the display is embodied as touchscreen, the user can respond to the confirmation inquiry directly via the display.

Finally, it is proposed that an operating plan of the cleaning device, in which future operating tasks are stored, is adapted as a function of an operating status of the household appliance. This procedure is advisable in particular when the cleaning device is not only used spontaneously by the user, but is controlled by a specified operating plan, which includes future operating tasks of the cleaning devices. This operating plan can in particular include cleaning uses, which are planned according to days of the week and/or times of day. Provided that an operating status of the household appliance then requires an operation of the cleaning device, the stored operating plan of the cleaning device is changed, namely preferably in such a way that the time of a cleaning schedule is delayed, is replaced, is supplemented or the like. It is in particular considered thereby that no person is present in the area to be cleaned, so that neither the person nor the cleaning operation of the cleaning device is disrupted.

### BRIEF DESCRIPTION OF THE DRAWINGS

The invention will be described in more detail below by means of exemplary embodiments.

FIG. 1 shows a system of a plurality of household appliances and a cleaning device comprising a central control device during a first point in time,

FIG. 2 shows the system according to FIG. 1 during a second point in time,

FIG. 3 shows a system of a household appliance and a cleaning device comprising a local control device during a first point in time,

FIG. 4 shows the system according to FIG. 3 during a second point in time,

FIG. 5 shows the cleaning device in a detailed view.

### DETAILED DESCRIPTION OF THE PREFERRED EMBODIMENTS

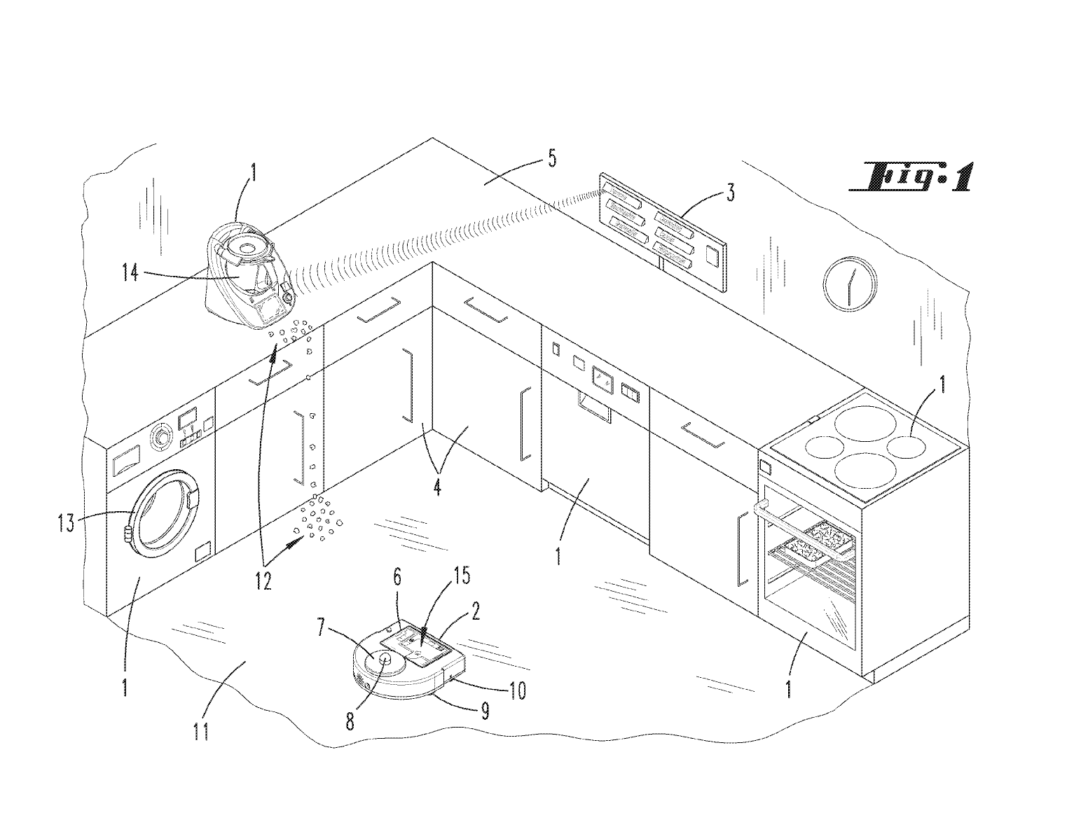

FIG. 1 shows a room of a home, namely a kitchen here. A plurality of kitchen cabinets 4 and household appliances 1 is present in the room, wherein the kitchen cabinets 4 furthermore have a worktop 5 resting thereon. Here, the household appliances 1 comprise appliances, such as, for example, a washing machine, a dishwasher and a stove-oven combination. An electric motor-operated kitchen machine comprising a preparation vessel 14 is furthermore located on the worktop 5.

An autonomous cleaning device 2, which can move automatically inside the room or, if applicable, also in adjacent rooms, is located on a floor 11 of the room. Here, the cleaning device 2 is for example a vacuum cleaner robot. In the alternative, however, it is also possible to embody the cleaning device 2 as a mopping robot or as a vacuuming-mopping combination. The cleaning device 2 has wheels 9, which are driven via an electric motor, as well as a cleaning element 10, which is also driven by means of an electric motor, here for example a bristle roller for treating the floor 11. The cleaning device 2 also has a navigation and self-localization device, by means of which the cleaning device 2 can orientate itself inside the room. The navigation and self-localization device include a distance measuring device 7 and an image capturing device 8, by means of which the cleaning device 2 captures its surrounding area. From the data, a surrounding area map 15 can be generated, which can include the kitchen cabinets 4, the household appliances 1 and, if applicable, further cleaning devices 2. The generated surrounding area map 15 is displayed, for example, on a display 6 of the cleaning device 2, among other things.

The cleaning device 2 and the household appliances 1, together with an external control device 3, form a system according to the invention. Here, the control device 3 is illustrated in a purely exemplary manner as a control panel, which has display elements for a current activity of the household appliances 1 and/or of the cleaning device 2. The control device 3, the household appliances 1 and the cleaning device 2 have communication modules, which are not illustrated in detail, here for example WLAN modules, with the help of which they can communicate with one another and with the central control device 3. The central control device 3 serves for example as access point of the WLAN network, with which the household appliances 1 as well as the cleaning device 2 communicate. According to this embodiment, a communication between for example a household appliance 1 and the cleaning device 2 or two household appliances 1 among one another, respectively, does not take place directly, but only via the control device 3.

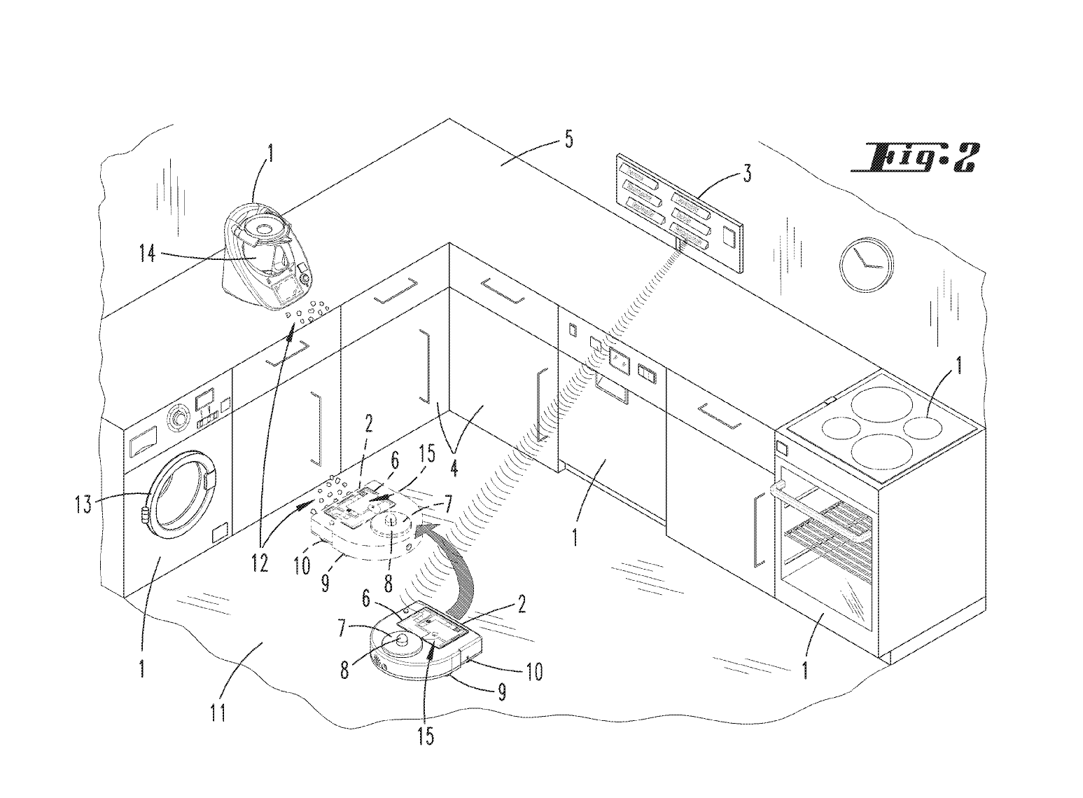

The household appliances 1 and the cleaning device 2 can now cooperate in such a way in terms of the invention that a fully automatic operation of the system results without assistance from a user. With regard to this, a first embodiment will be described below by means of FIGS. 1 and 2.

In FIG. 1, the household appliance 1, which is embodied as kitchen machine, is in an operating mode. Food located in the preparation vessel 14 is thereby prepared, for example comminuted, stirred, heated or the like. Prior to the preparation, a user has to introduce the ingredients into the preparation vessel 14, wherein ingredients might fall next to the household appliance 1 onto the worktop 5 and further onto the floor 11 of the displayed room. Parts of an ingredient are illustrated on the floor 11 here, which will be identified as dirt 12 below. When the preparation operation of the household appliance 1 has ended, the user removes the food from the preparation vessel 14, whereby dirt 12 can in turn reach the floor 11. To now attain a fully automatic elimination of the dirt 12, i.e. without assistance from the user, the household appliance 1 transmits information about its current operating state to the central control device 3 by means of its communication module. Here, the information can include information, for example, that the preparation of the food has been fully completed. The operating status of the household appliance 1 can thereby for example be identified as “preparation completed”.

The control device 3 receives the information from the household appliance 1 and processes it into a control command for the cleaning device 2. The control command includes instructions for moving the cleaning device 2 to that partial area of the floor 11, on which dirt might be present. For this purpose, the control command includes information about the location of the household appliance 1. The control device 3 accesses a surrounding area map 15 of the room and can determine the corresponding location by means of a transmitted device identification of the household appliance 1. After receiving the control command, the cleaning device 2 moves towards the dirt 12 and performs a cleaning using suction, using the cleaning element 12 and a motor-fan device, which is not illustrated in more detail. FIG. 2 shows the reaction of the cleaning device 2 to the control command, which is transmitted by the control device 3, suggested by an arrow as well as the target position, which is illustrated in a dashed manner.

So that the household appliances 1 and the cleaning device 2 or also a plurality of cleaning devices 2, respectively, can cooperate advantageously within the system, they need to first be registered at the central control device 3. In response to the registration, each of the household appliances 1 or of the cleaning devices 2, respectively, has to transmit its device identification, its current or permanent device location (provided that it is a stationary device, such as a kitchen machine), as well as a current operating status, if applicable, to the control device 3. The control device 3 processes this information in a database, within which the information from the household appliances 1 and the cleaning devices 2 is stored. The device ID assigned to each household appliance 1 or cleaning device 2, respectively, is also transmitted in response to the transmission of information to the control device 3. The control device 3 furthermore has routines, which are controlled as a function of an operating status of one of the household appliances 1. In the case of the kitchen machine shown in FIGS. 1 and 2, a control command for a cleaning is generated in the area of the kitchen machine and is transmitted to the cleaning device 2 in response to receiving the operating status “preparation concluded”. Provided that the system has a plurality of cleaning devices 2, the control device 3 can also check, which cleaning device 2 is available and/or is located closest to the area of the floor 11 to be cleaned, in which dirt 12 can be assumed. In the alternative, the control device 3 could transmit a control command to all cleaning devices 2, whereupon the cleaning devices 2 in each case check by means of their surrounding area map 15, which cleaning device 2 is closest to the location of the dirt 12, and only that cleaning device 2, which has the shortest way, then moves to that location. The other cleaning devices 2 remain at their previous device location.

In addition, provision can be made for a confirmation inquiry to be initially transmitted to a user of the system after receiving a control command from the control device 3 at a cleaning device 2. This confirmation inquiry can for example be displayed on the display 6 of the cleaning device 2. The user has to respond to this confirmation inquiry, so that the control command takes effect, i.e. the cleaning device 2 is controlled according to the content of the control command. In the event that the display 6 is for example a touchscreen, the user can confirm the confirmation inquiry by touching the display 6. In the alternative, provision can also be made for an external end device to be in communication connection with the cleaning device 2, for example a mobile telephone of the user. The confirmation inquiry can likewise be illustrated and confirmed thereon.

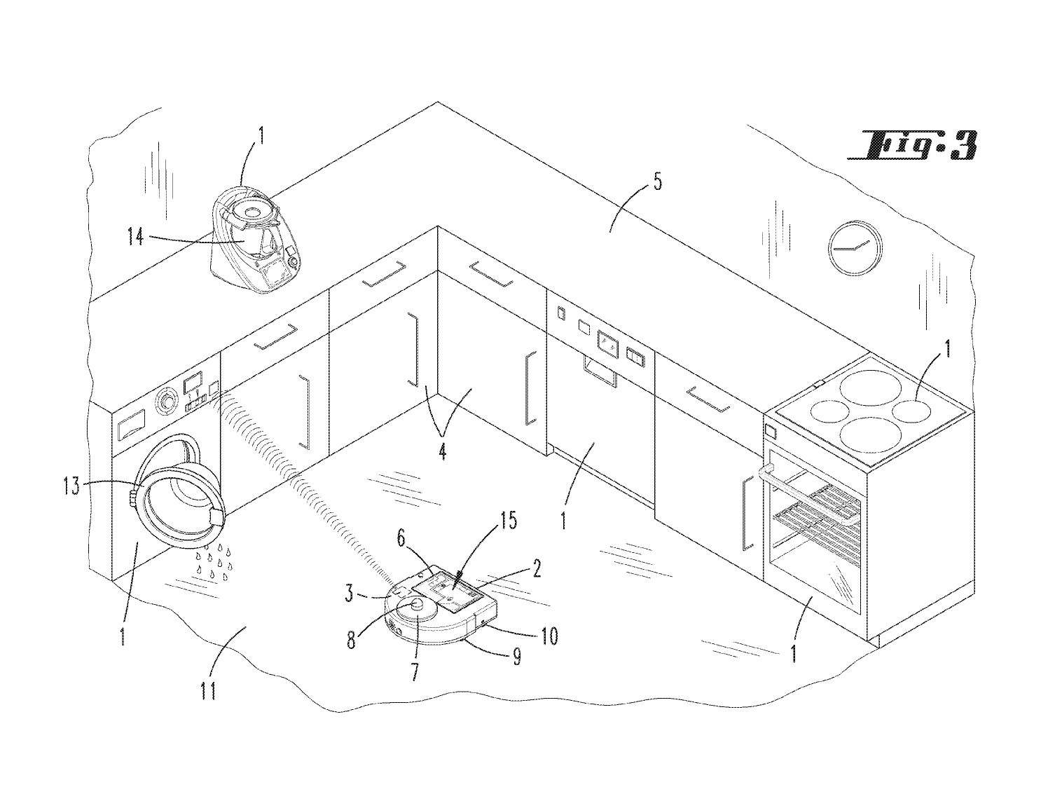

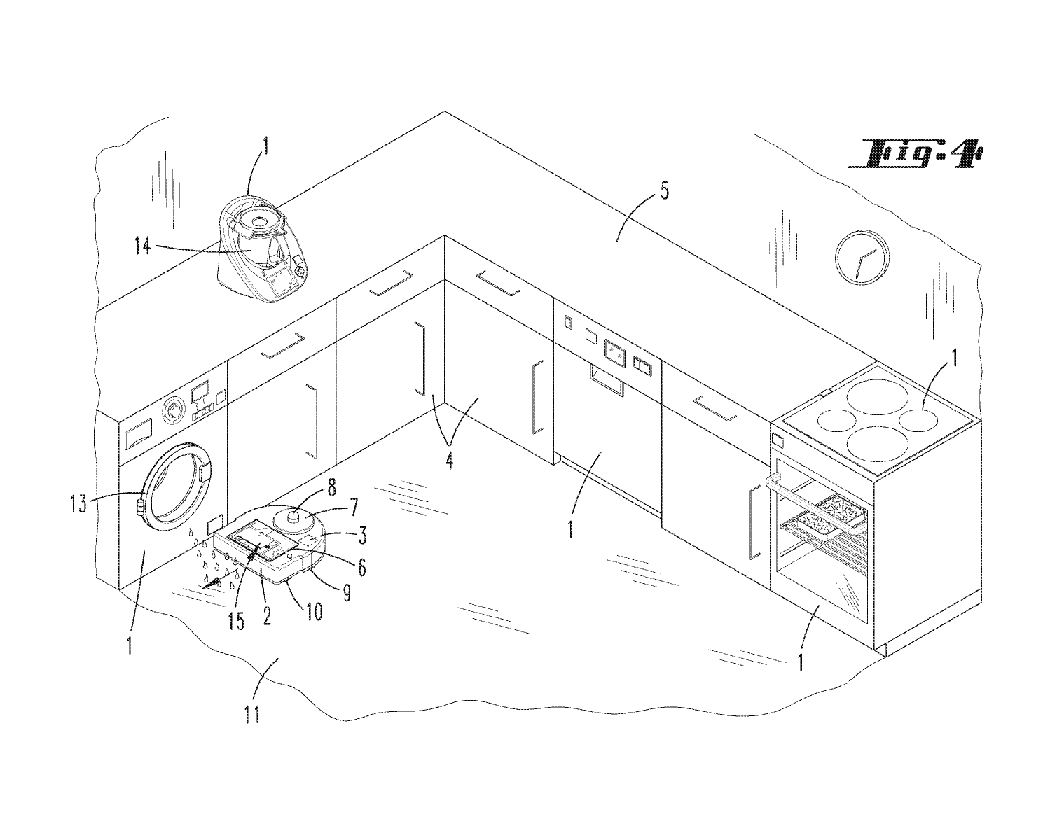

FIGS. 3 and 4 show a second embodiment of the invention, in which the system does not have an external control device 3, but a local control device 3 of the cleaning device 2 simultaneously forms a central control device 3 of the system. The system has a plurality of household appliances 1 as well as the cleaning device 2. In the illustrated situation according to FIG. 3, the household appliance 1, which is embodied as washing machine, has just completed a washing process. The user has opened an appliance door 13 of the household appliance 1 to remove laundry, wherein liquid drops have dropped from the laundry onto the floor 11. Without further assistance from the user, the system is now set up to eliminate the liquid drops located on the floor 11. For this purpose, the household appliance 1 transmits its operating status “washing process completed” and/or “door open” to the control device 3 of the cleaning device 2, which acts as central control device 3 of the system. With the operating status, the device identification of the household appliance 1 is also transmitted to the control device 3. The control device 3 receives the information and checks by means of the surrounding area map 15 of the cleaning device 2, at which device location the household appliance 1 is located. The control device 3 then generates a control command for the cleaning device 2, which includes the instructions to move to the area of the floor 11, which has the liquid drops, and to mop up the liquid drops there by means of the cleaning element 10. Here, the cleaning element 10 of the cleaning device 2 is advantageously a cleaning roller covered with a cleaning textile. The cleaning process is illustrated in FIG. 4. The cleaning device 2 thereby mops the area of the floor 11 below the appliance door 13 of the household appliance 1.

Provided that, in addition to the illustrated cleaning device 2, the system furthermore also has other cleaning devices 2, the one cleaning device 2 can nonetheless have the central control device 3 and can transmit a generated control command to another cleaning device 2, if applicable.

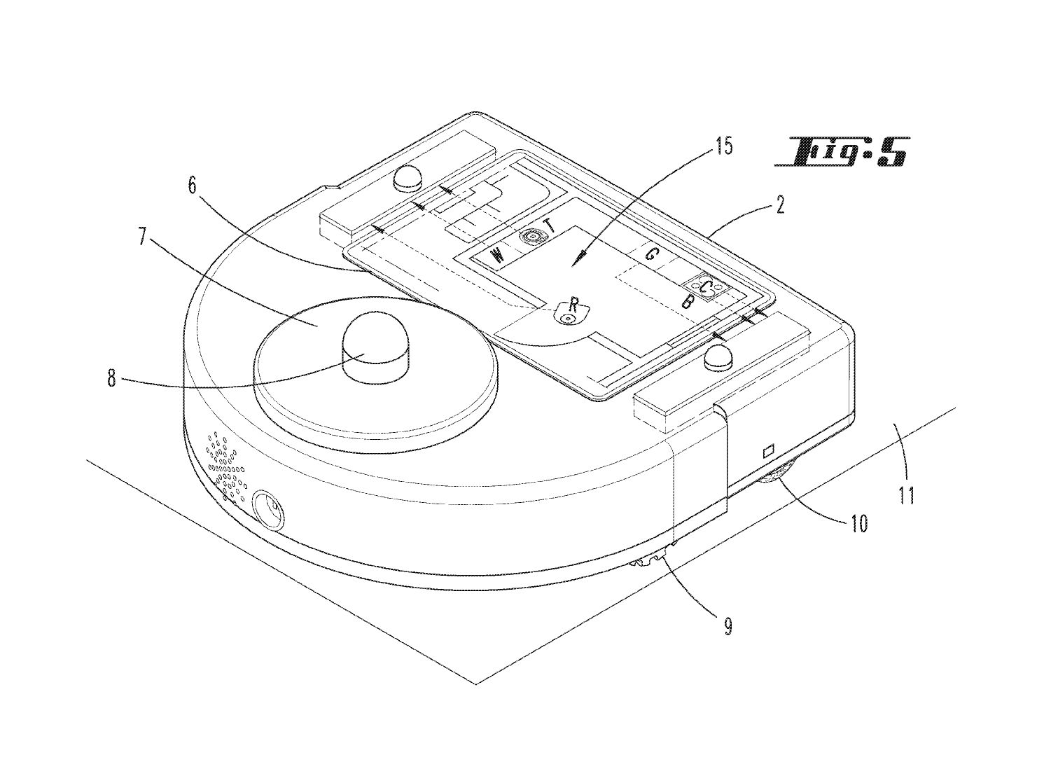

Finally, FIG. 5 shows an enlarged illustration of an exemplary cleaning device 2. A surrounding area map 15 of the cleaning device 2, which includes a floor plan of the room, in which the cleaning device 2 is currently located is displayed on the display 6. The kitchen cabinets 4, household appliances 1 and, if applicable, further cleaning devices 2, are furthermore denoted in the surrounding area map 15. A current activity of one of the household appliances 1 or of a cleaning device 2 can be displayed in the surrounding area map 15 for example by an illumination, a special chromaticity or the like. A user of the cleaning device 2 can thus recognize, which household appliance 1 currently has an active operating status and, if applicable, will shortly call the cleaning device 2. An additional file, in which an operating plan of the cleaning device 2 is stored, can furthermore be associated with the surrounding area map 15. This operating plan includes work tasks of the cleaning device 2, advantageously in a calendar-like table with days of the week and times of day. Provided that the cleaning device 2 now receives a control command for moving into a certain area of the room, the cleaning device 2 can initially check by means of its operating plan, whether a different cleaning task is currently present or in the near future. If applicable, a consideration then has to be made whether the control command is maintained or changed, if applicable as a function of whether further cleaning devices 2 are available within the system, which could alternatively follow the control command.

### LIST OF REFERENCE NUMERALS

1 household appliance
2 cleaning device
3 control device
4 kitchen cabinet
5 worktop
6 display
7 distance measuring device
8 image capturing device
9 wheel
10 cleaning element
11 floor
12 dirt
13 appliance door
14 preparation vessel
15 surrounding area map

What is claimed is:

1. A system of at least one household appliance, at least one automatically moving cleaning device, and a control device for controlling an operation of the cleaning device, wherein the control device is configured to control an operation of the cleaning device as a function of an operating status of the household appliance, and wherein the household appliance and/or the cleaning device is configured to transmit its device type, current device location and/or current operating status to the control device.

2. The system according to claim 1, wherein the household appliance is selected from the group consisting of a kitchen machine, a window cleaning device, a washing machine and a clothes dryer.

3. The system according to claim 1, wherein the control device is an integrated control device of the cleaning device or an external control device, and wherein the control device has a communication connection to the cleaning device and to the household appliance.

4. The system according claim 1, wherein the system has a communication network, in which the household appliance and the cleaning device are in communication connection with one another via the control device.

5. A method for operating a system of at least one household appliance, at least one automatically moving cleaning device, and a control device for controlling an operation of the cleaning device, comprising the following steps:
controlling with the control device an operation of the cleaning device as a function of an operating status of the household appliance, and
transmitting by the household appliance and/or the cleaning device information regarding a device type, current device location and/or current operating status to the control device.

6. The method according to claim 5, further comprising the step of outputting with the control device a control command for moving the cleaning device to the device location of the household appliance and for performing a cleaning operation at the device location, whereupon the cleaning device moves to the household appliance and performs a cleaning there.

7. The method according to claim 5, wherein the control command for the cleaning device is output at the beginning and/or upon completion of an operation of the household appliance.

8. The method according to claim 5, further comprising transmitting with the control device a confirmation inquiry to a user of the system prior to transmitting the control command to the cleaning device, and displaying the confirmation inquiry on a mobile end device of the user.

9. The method according to claim 5, wherein an operating plan of the cleaning device, in which future operating tasks are stored, is adapted as a function of an operating status of the household appliance.
